(19) United States
(12) Patent Application Publication
(10) Pub. No.: US 2011/0308637 A1
(43) Pub. Date: Dec. 22, 2011

(54) DEVICE FOR SETTING THE GAS PRESSURE IN A MOTOR VEHICLE TIRE

(75) Inventor: Konstantinos Tsiberidis, Heilbronn (DE)

(73) Assignee: KT PROJEKTENTWICKLUNGS-GMBH, HEILBRONN (DE)

(21) Appl. No.: 13/148,568

(22) PCT Filed: Feb. 9, 2010
(86) PCT No.: PCT/EP10/51548

§ 371 Date: Aug. 9, 2011

(30) Foreign Application Priority Data
Feb. 10, 2009 (DE) 102009008314.6
Feb. 20, 2009 (DE) 102009009879.8
Aug. 18, 2009 (DE) 102009037803.0

(51) Int. Cl. F16K 15/20

(52) U.S. Cl. 137/223

(57) ABSTRACT

The invention relates to a device for setting the gas pressure in a motor vehicle tire, comprising: at least one first channel element, which is arranged in a substantially rotationally fixed manner in the area of a wheel axle of the motor vehicle and which forms a part of a ring channel that is arranged concentrically with the wheel axle, wherein the first channel element comprises a connection for a pressure medium line, which is connected to a pressure medium source, at least one second channel element, which can be rotated together with the motor vehicle wheel and which forms another part of the ring channel and which is connected to the interior of the motor vehicle tire by means of an inlet valve, wherein the first channel element and the second channel element face each other with the parts thereof that form the ring channel. The tire pressure can be corrected during driving and at standstill by means of such a device.

The present invention relates to a device for measuring and setting, respectively correcting the gas pressure in a motor vehicle tire. Known from German patent DE 199 61 020 is a means for automatic tire pressure control wherein the interior of the tire is connected to a compressed air feeder incorporated in the wheel axle. Although such a device is effectively capable of connecting the tire to a fixed compressed air connection for controlling the tire pressure, the drawback of this device is that providing a compressed air feeder in the center of the wheel axle is problematic in manufacture, making production costly. In addition, connecting the central compressed air feeder to an adapter rotating with the vehicle wheel is difficult since the adapter has to rotate relative to the compressed air feeder in the wheel axle at the same speed as that of the vehicle tire.

The object of the invention is to provide a device which now makes it possible to detect and control the pressure in a motor vehicle tire by simple ways and means.

This object is achieved in accordance with the invention by the features of claim 1 or 18. A motor vehicle having such a device is the subject matter of claim 21.

In one aspect of the invention an annular passageway is provided to transfer the compressed air from its source to the tire. The annular passageway is defined by a first passageway element provided substantially non-rotatable relative to the wheel axle and by a second passageway element which rotates with the wheel of the motor vehicle. In this arrangement the two passageway elements are preferably provided in the region of the brake disk flange to save space, they substantially forming a closed annular passageway for feeding a pneumatic flow, e.g. compressed air from a stationary source thereof in the motor vehicle, to the corresponding tire. Configured at the non-rotatable first passageway element is at least one connection for a pneumatic flow line connected to the source, so that the compressed air or some other gas can be fed for vehicle tire inflation via the first passageway element into the annular passageway. Provided preferably in the connection is a controllable valve by means of which the connection between the pneumatic flow source and annular passageway can be opened controlled. The second passageway element comprises an inlet valve, particularly as a type of check valve via which the second passageway element is connected to the interior of the vehicle tire. Inflation is initiated when the pressure in the annular passageway formed by the two passageway elements is higher than the pressure in the interior of the vehicle tire. When the pressure is lower, the inlet valve closes by known ways and means so that no air can bleed from the vehicle tire back into the annular passageway.

It is understood that a substantially closed annular passageway assumes that a small gap d remains between the facing parts or edges of the first and second passageway elements forming the annular passageway, said gap being so small that any loss of pressure therethrough can be sufficiently compensated by the pneumatic feed via the connection of the first passageway element so that a pressure higher than in the vehicle tire can be generated in the entirety of the annular passageway. Preferably the gap between the sealing edges/parts of the two passageway elements ranges from 0.05 to 3 mm, particularly from 0.2 to 1 mm. Configuring the annular passageway in this way has the advantage that no friction occurs between the stationary and rotating parts of the annular passageway so that wear or bleed pose no problem. The gap materializing between the edges or parts of the first and second passageway elements is simply maintained as small as possible within the scope of what is technically possible so that the pressure losses through the gap are minimized. Configuring it in this way is very friendly for maintenance because no sealing elements requiring care need to be provided. This is because, for one thing, the gap between the first and second passageway element is continually purged clean by the outward pneumatic flow from the annular passageway so that no debris can accumulate in the region of the gap of the annular passageway.

The advantage of the device in accordance with the invention is that not only new but also existing motor vehicles can now be simply fitted or respectively retrofitted with such a pressure control system.

Preferably the pneumatic feed via the pneumatic flow line is controlled by a controller which is signaled the target pressure and also indicates values for the wanted pressure in the vehicle tire. It is this electronic controller that now makes it possible to simply control the pneumatic flow to the corresponding tire via a control valve which may be sited anywhere between the pneumatic feed and the first passageway element.

Since, as viewed from the outer side of the vehicle the first and second passageway elements are preferably sited downstream of the brake disk and preferably within the flange of the brake disk, the complete device is, for one thing, well protected from any physical harm and, for another, the gap between the first and second passageway element can be set facilitated preferably by means of an assembly aid, especially by means of a spacer.

The facing sealing edges/rims of the first and second passageway element are preferably sited so that the gap formed therebetween is located in a plane transversely to the wheel axle or parallel thereto.

In one embodiment which is simple to produce and install the passageway elements take the form of disks installed juxtaposed in forming the annular passageway by the facing parts of the annular passageway, whereas in another advantageous embodiment the first passageway element has the shape of a cylindrical ring in the second passageway element as a kind of cylindrical bush. To minimize friction one special embodiment for pressurization with the vehicle stationary provides for the first passageway element being sealingly urged against the second passageway element in the annular passageway by means of the increase in pressure.

Where the wheel axle mounts twin tires two concentric annular passageways may be provided for each tire of the axle, permitting separate pneumatic control of each tire of the twin arrangement. The advantage of this arrangement is that the load on the twin tires is well distributed, enabling continued run-flat operation for a limited period of time when one of the tires is damaged.

One aim basic to the invention is there being no need to provide a permanent absolute seal between the stationary and moving parts of the pneumatic feed in supplying compressed air to the tire. Either a predefined gap size is provided which when disposed between the stationary and rotating elements results in the leakage problems involved in conventional contact-based pneumatic sealing arrangements being avoided, especially in eliminating wear due to contact friction of sealing faces, or it is provided for that during pressurization with the vehicle stationary one passageway element is maintained shiftable for a good seal so that it is then urged against the complementary passageway element with an increase in pressure in the annular passageway.

The outcome of this device in accordance with the invention is thus it being very much more maintenance-friendly than known devices whilst achieving highly effective inflation and, if needs be, even a depressurization in a vehicle tire simply by means of a controller-activated solenoid valve connected to the pneumatic flow line between the control valve of the passageway element and the tire which, when activated, opens to bleed air/gas from the tire to the environment.

The invention thus now makes it possible to inflate and deflate the tire both when the vehicle is on the move and stationary.

In a further embodiment an additional second annular passageway may be provided as an outlet annular passageway used in deflating the tire. This outlet annular passageway is disposed coaxially to the first annular passageway between the first and second passageway element. The part of the outlet annular passageway formed in the first passageway element is connected to a pneumatic feed line connection connecting the pneumatic flow source. Here too, in this connection or in the pneumatic flow line a control valve is provided preferably solenoid-activated via the electronic tire pressure controller.

The part formed in the second passageway element is connected to an actuator of an outlet valve which on pressurization connects the interior of the vehicle tire to a low-pressure area, particularly the environment and thus this valve is actuated by the pressure in the outlet annular passageway. On pneumatic actuation of the actuator, especially of an actuation surface, the outlet valve can be caused to open by means of the outlet annular passageway, as a result of which pressure is bled from the vehicle tire into the low-pressure area, particularly the environment.

Provided thus in such a device is a concentric arrangement of two annular passageways, one for inflation and one for deflation, achieving open or closed circuit control of the pressure in the annular passageway and in the outlet passageway and thus the tire pressure in accordance with the conditions at any one time in tire negotiation simply by correspondingly activating the control valves. For, when negotiating a softer surface the pressure can be somewhat reduced in all tires for a better traction, whilst on a dry road surface the tire pressure can be increased to achieve a reduced footprint (frictional resistance). Achieving this may be automated by means of the controller, also in conjunction with the vehicular central controller, in response to predefined parameters.

Pneumatic control is preferably done by activating one of the two control valves in the connection of the first passageway element for the pneumatic flow line or of a valve in the pneumatic flow line itself. Opening this control valve pressurizes the corresponding annular passageway with the pressure of the pneumatic flow source in accordance with the pressure existing in the vehicle tire, resulting in an increased inflation or deflation of the tire as a function of the pneumatic feed of the annular passageway or outlet annular passageway. For this purpose the valves connecting the first passageway element and the outlet passageway element may be solenoid valves. The valves in the second passageway element are preferably pneumatic flow valves which respond in such a way that both the pressure acting on the control valve in the first annular passageway of the first passageway element exceeds a threshold pressure to open the control valve to ensure that this pressure is sufficient to inflate the tire irrespective of any loss in pressure due to leakage between the passageway elements, it being this pressure that opens the valve in the second passageway element in the first annular passageway, whereas when the outlet valve in the second annular passageway, i.e. the outlet annular passageway, in the second passageway element is pressurized, the activating pressure may be less than inflation pressure to open the valve and bleed the tire pressure.

In another alternative embodiment it is also possible to inflate as well as to deflate the tire with just one annular passageway by using pressure control valves. In this case, the second passageway element of the annular passageway features a connection to both the inlet valve of the vehicle tire and to the actuator of an outlet valve of the vehicle tire. In this arrangement the connection to the inlet valve in the annular passageway is simply staggered at an angle to the connection of the actuator for the outlet valve.

The inlet valve and/or outlet valve may be likewise pneumatically activated as described above. Whilst the outlet valve requires a lower activation pressure to open in deflating the tire, the inlet valve needs a higher pressure to be activated. Since in this embodiment both valves are sited in one and the same annular passageway the outlet valve will, of course, always open whenever the inlet valve is to be actuated. This is why the pressure for activating the inlet valve needs to be set so high that despite leakage losses due to the outlet valve and any seals provided, inflating the tire can nevertheless be assured. Against this backdrop it is thus an advantage to select the cross-section of the outlet valve suitably small so that the losses due to this valve when inflating the tire are not excessive.

As an alternative, however, it can be defined by timing the control of the control valve connecting the first passageway element whether the control valve is opened via the connection to the inlet valve or via the connection to the actuator. In this case is then expedient to provide two radial webs in the parts of the second passageway element forming the annular passageway so that two sectors of the annular passageway are provided each separate from the other. The first passageway element then preferably forms just a wall of the annular passageway so that angularly two sectors of the annular passageway can each have its own pressure. The one sector is connected to the inlet valve, the other to the actuator of the outlet valve so that the tire is either momentarily inflated or deflated depending on which sector is pressurized. This, of course, necessitates detecting the position of each of the two passageway elements relative to the other and as a function thereof controlling the control valve connecting the pneumatic flow line of the first passageway element. It is in this way that the tire pressure can be both increased and decreased by means of a single passageway. It is understood that the sectors must not necessarily be the same in size, the angular range of each may also differ. Thus the angular range of the one sector may be made larger at the expense of the other to, for example, achieve effective inflation in fast rotation of the wheel when the vehicle is on the move. In other words the inflation sector may be larger with the advantage that activating the pneumatic feed can be done over a larger angular range.

Providing in this case, e.g. two identical concentric passageways would enable each of twin tires on the same axle to be activated separately both for pressurization and depressurization.

Preferably the individual passageway elements are engineered integral, i.e. each in one piece so that as few components as possible need to be provided in both the stationary and rotating part of the vehicle axle. In addition, an integrated part is naturally less susceptible to becoming dirty and damaged.

Preferably the elements of the annular passageway, i.e. the first and second passageway elements are made of aluminum to keep the weight of the device in accordance with the invention within acceptable limits. Thus, together with a corresponding controller for open and closed control in detecting the pressure in each tire a highly effective control system can be developed which is capable of considerably enhancing safe and stable vehicle handling.

The invention has the advantage of improving the run-flat performance of any tire by, e.g. making it possible to maintain the tire pressure as needed as long as the leakage due to tire damage is less than the pneumatic feed made possible by the device in accordance with the invention.

It is, of course, also possible to provide a low-friction seal in the region of the gap between the first and second passageway element, such as, e.g. a lip or brush-type seal, although preference is to be given to non-contact type seals such as e.g. a labyrinth-type seal in the region of the gap.

In one special embodiment (see claim 18) it is provided for that the annular passageway is totally integrated in a toroidal element, in other words, not comprising two passageway elements. This toroidal element is preferably the element entrained in the rotation of the vehicle wheel. This element may also be the second passageway element, circumstances permitting, which then in addition to the part forming the halved annular passageway fully includes a further annular passageway. The annular passageway relative to the front face of the toroidal element facing that of a complementary toroidal element connecting the pneumatic flow source via a control valve has at least two ports siting check valves capable of porting into, but not out of, the integral annular passageway. When, with the vehicle on the move, the outlet port of the pressurized front face of the first passageway element covers the corresponding port of a check valve, the latter opens and directs the pneumatic flow therethrough into the integral annular passageway from which it flows via the valve arranged in the integral annular passageway to the inlet side of the vehicle tire.

It is due to this integral annular passageway closed off by the check valves to the pneumatic inlet side that pressure losses are minimized.

To increase the porting degree with which the pneumatic outlet of the first, i.e. substantially non-rotatable arranged toroidal element covers the ports of the check valves, this first non-rotatable toroidal element may take the shape of the first passageway element as described above in which part of the annular passageway is already formed. Due to this part of the annular passageway there is continual correspondence between the outlet side of the first toroidal element and the ports for the check valves of the other opposite toroidal element, it being understood, of course, that more than two ports with check valves may be provided in the second toroidal element.

In still a further aspect the first toroidal element is formed by the first passageway element and the second toroidal element by the second passageway element with its already furnished complementary part for the further annular passageway. It may furthermore be provided for that the part of the annular passageway formed by the first passageway element is shaped, for example wavy, so that this annular passageway is always actively connected to at least one check valve.

The invention will now be detailed by way of example with reference to the diagrammatic drawings in which:

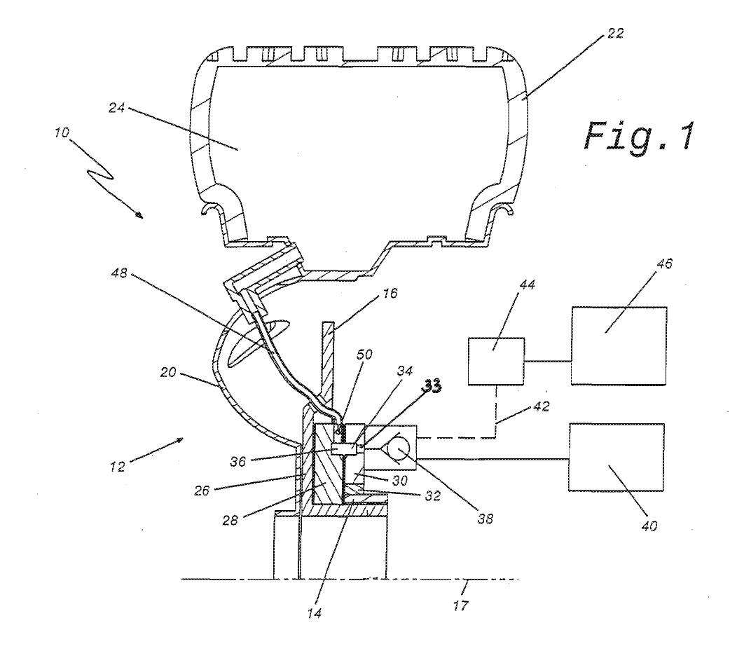

FIG. 1 is a partly cross-sectioned diagrammatic view of the device in accordance with the invention in the region of a motor vehicle tire,

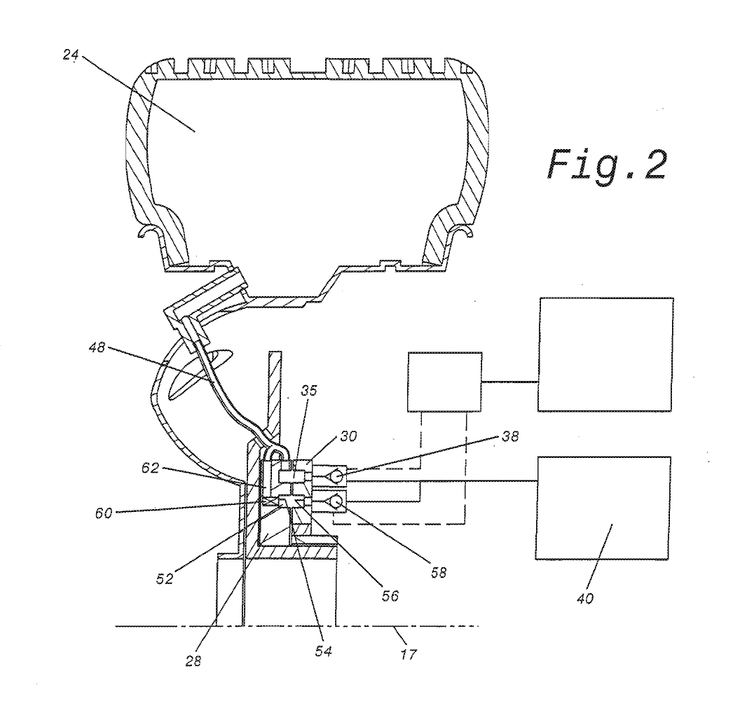

FIG. 2 is a view showing an embodiment similar to that as shown in FIG. 1 featuring an additional outlet annular passageway to reduce the pneumatic pressure in the vehicle tire,

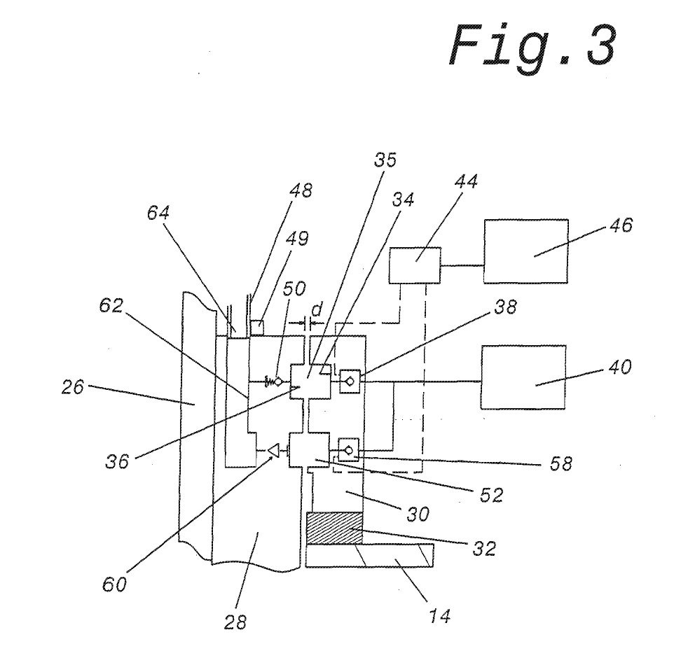

FIG. 3 is a view detailing the device in accordance with the invention as shown in FIG. 2 showing the components used for vehicle tire pneumatic control,

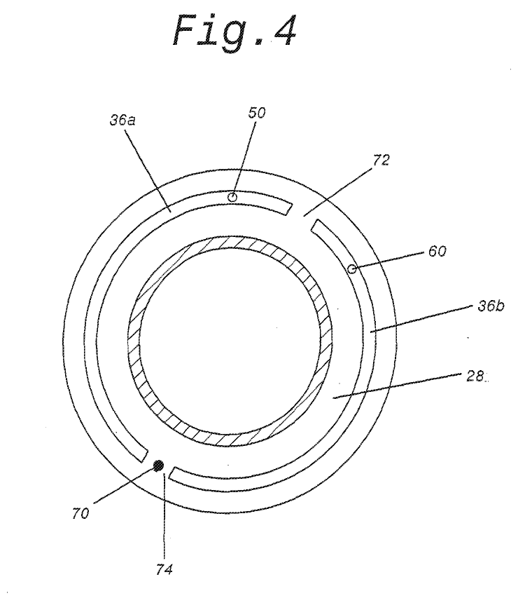

FIG. 4 is a top-down view of the second passageway element in an embodiment alternative to that as shown in FIG. 1 in which by means of an annular passageway the vehicle tire pressure can be both increased or decreased,

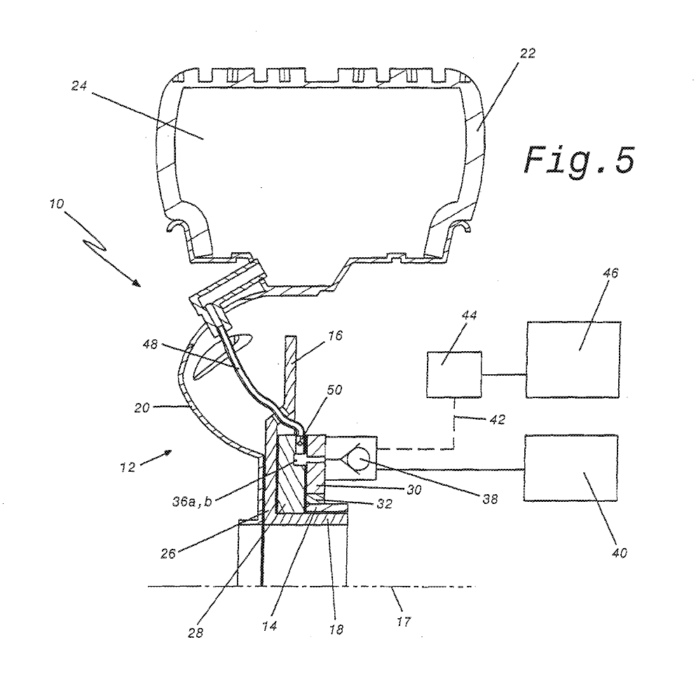

FIG. 5 is a view as shown in FIG. 1 but corresponding to the embodiment as shown in FIG. 4,

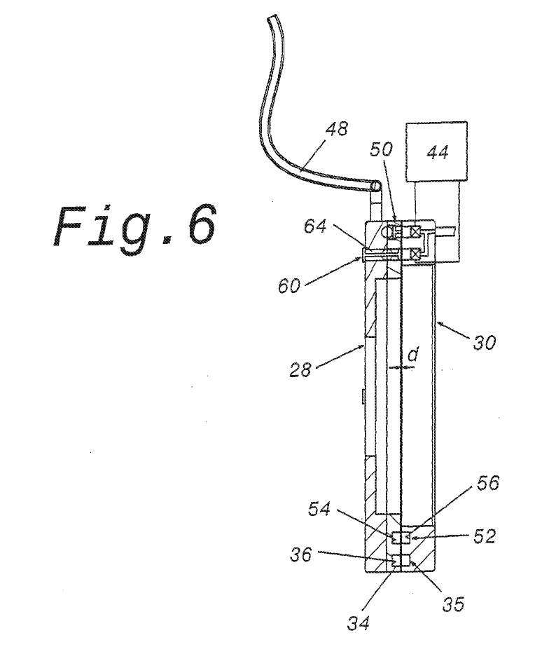

FIG. 6 is a partly sectioned view of a more advanced embodiment of that as shown in FIGS. 3 to 5, and

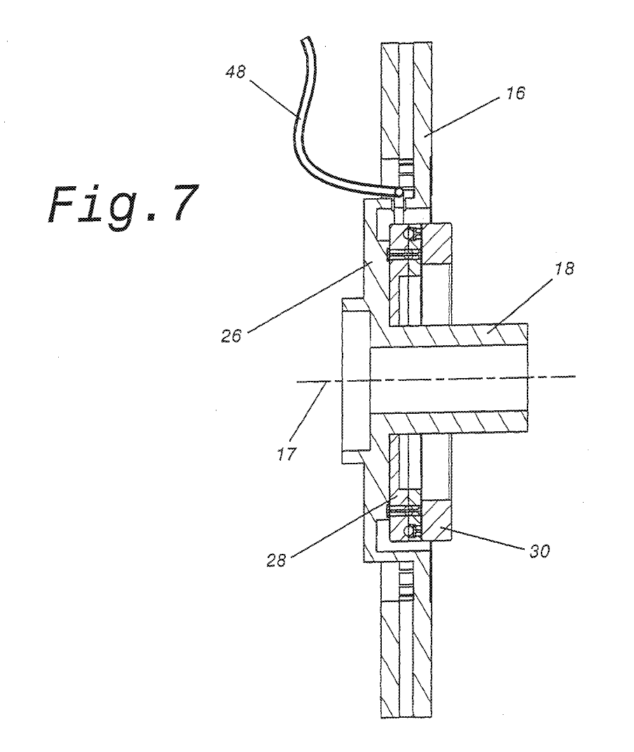

FIG. 7 is a view of the embodiment as shown in FIG. 6 when fitted within the brake disk flange;

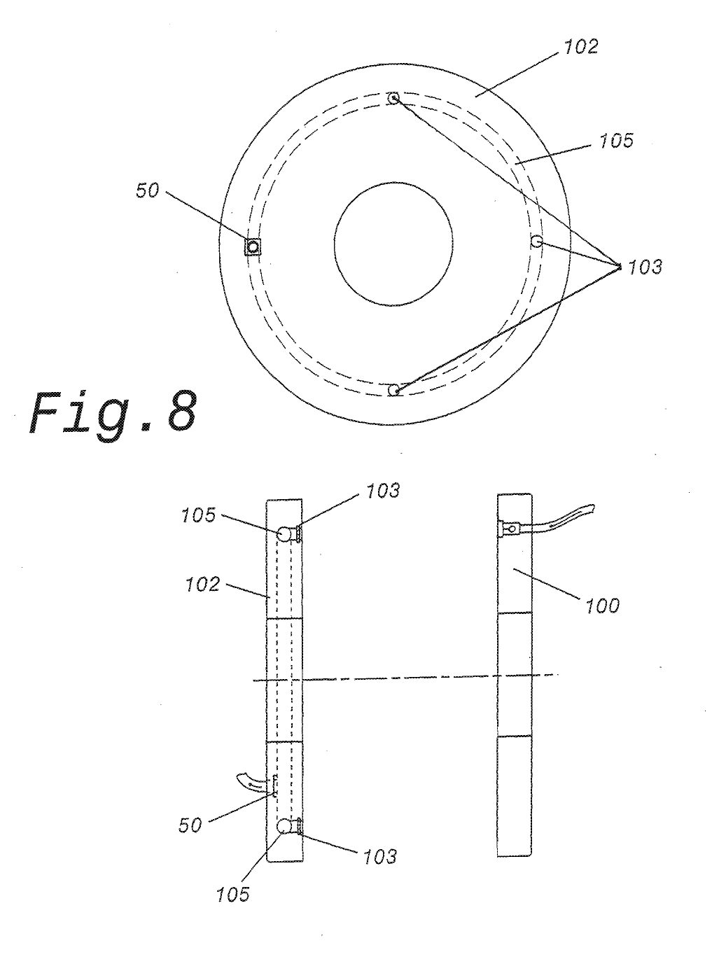

FIG. 8 is a cross-sectional view of a further embodiment featuring an integral separate annular passageway. Furthermore,

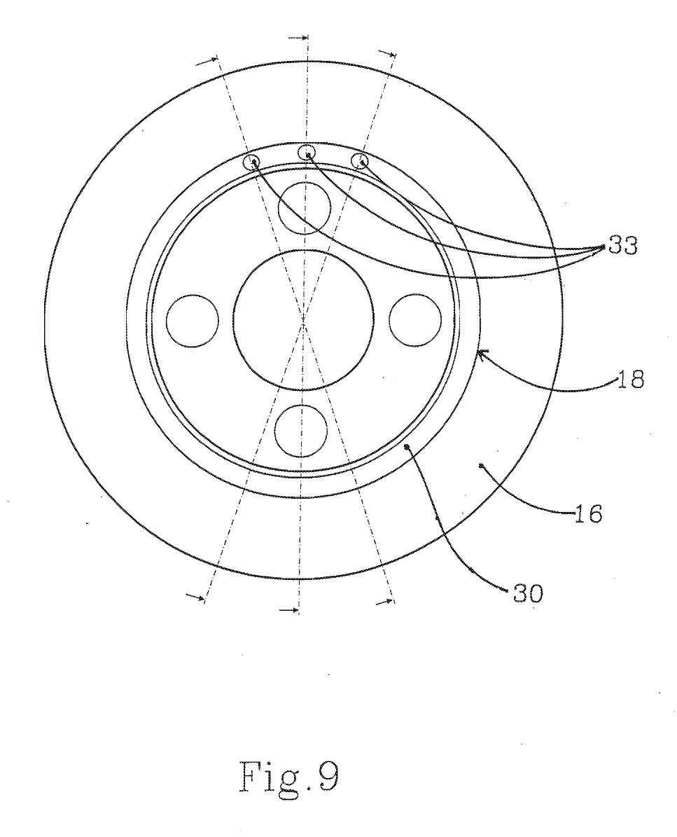

FIGS. 9 to 13 show a further embodiment of the invention in which brake disk cooling is integrated, where FIG. 9 is a top-down view of the brake disk of this embodiment

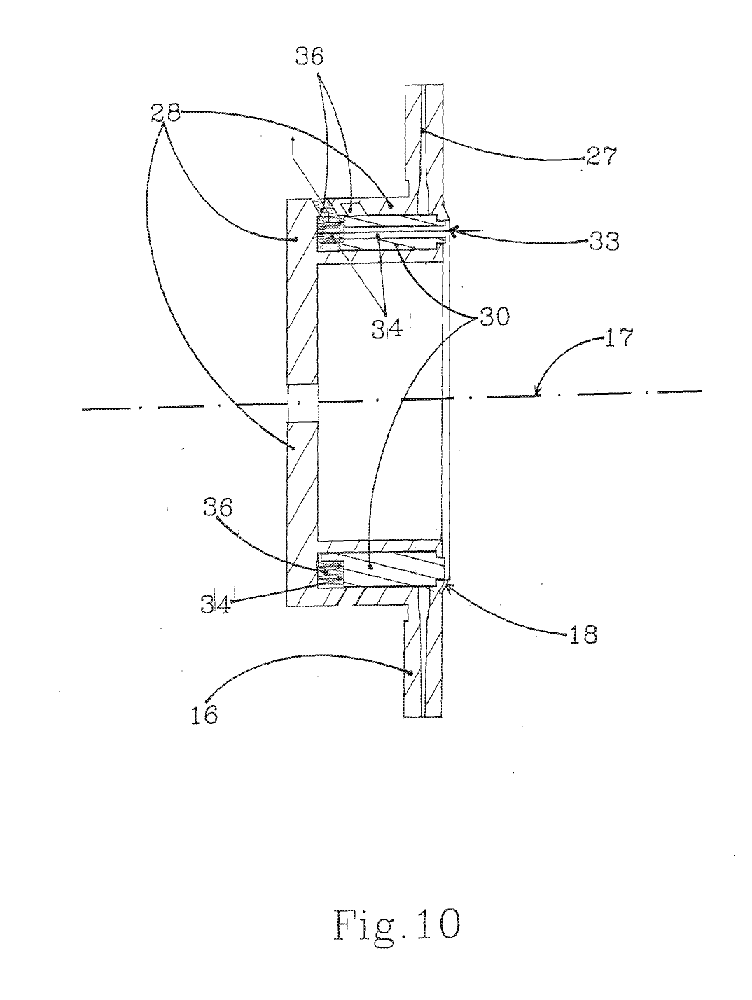

FIG. 10 is a sectional view taken along the line as shown in FIG. 9,

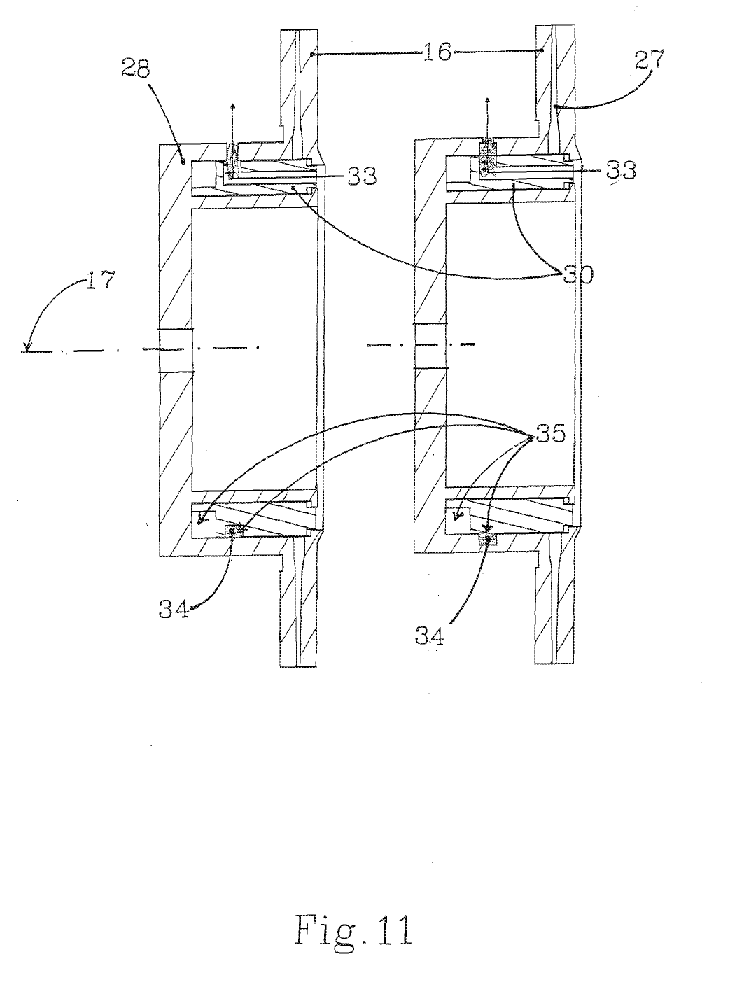

FIG. 11 is again a sectional view taken along the line as shown in FIG. 9, but unlike FIG. 10 showing a process condition of the invention in which the tire is inflated with the vehicle on the move,

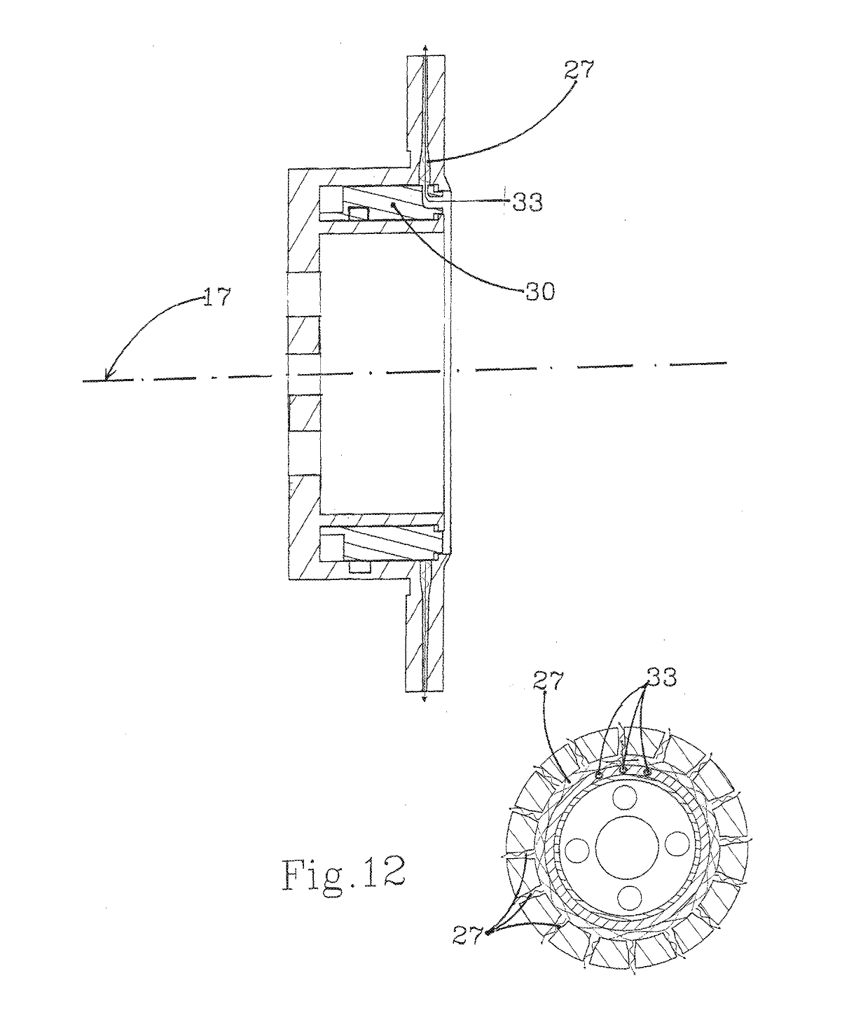

FIG. 12 is again a sectional view taken along the line as shown in FIG. 9, but showing the function in releasing the brake, and

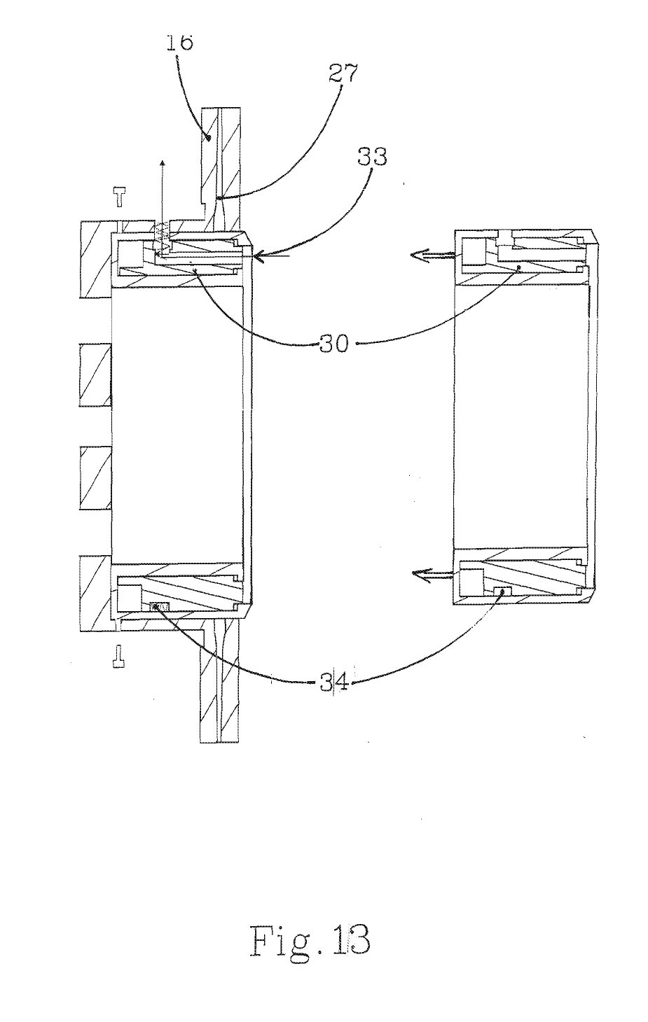

FIG. 13 is an example embodiment disclosing how an element can be retrofitted to an existing brake disk;

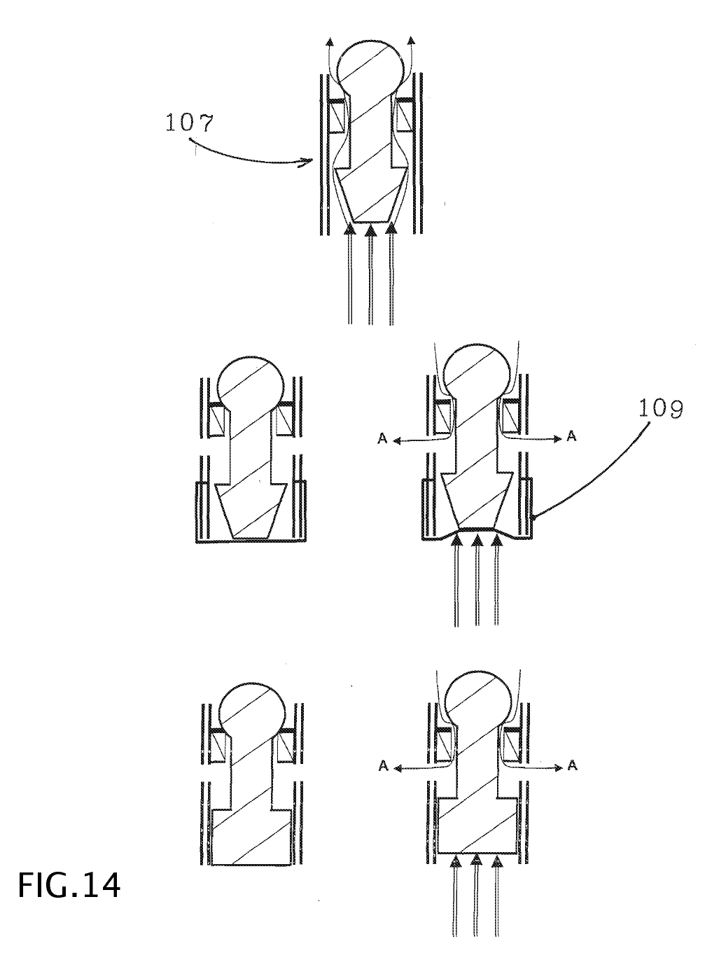

FIG. 14 is an example embodiment of a pneumatic valve.

Referring now to FIG. 1 there is illustrated the compressed air device 10 in accordance with the invention as realized in the region of a vehicle wheel 12 showing a stationary part 14 of a wheel axle 17 within which the shaft connected to a brake disk 16 for driving the vehicle wheel 12 is arranged. The vehicle wheel 12 itself consists of a rim 20, the outer circumference of which mounts a vehicle tire 22 so that between the rim 20 and the vehicle tire 22 an interior 24 of the tire is defined in which the pressure of the vehicle tire 22 is set. Secured to the brake disk mount 26 of the brake disk 16 is a second disk-shaped passageway element 28 which rotates together with the vehicle wheel 12. It is understood that in the FIGS. 1 to 3 and 5 the device in accordance with the invention is shown incomplete just above the wheel axle 17.

Arranged on the stationary part 14 of the wheel axle is a first passageway element 30 by means of an assembly aid 32 via which the gap d (FIG. 3) between the first passageway element 30 and the second passageway element 28 can be set as well as horizontally aligning the passageway elements 28, 30 forming the corresponding annular passageway. On its side facing the second passageway element 28 the first passageway element 30 has a cavity 34 sited opposite a further cavity 36 in the second passageway element 28. These two cavities 34, 36 form together an annular passageway 35. Connected to the cavity of annular passageway 34 is a control valve 38 which is connected to a pneumatic flow source 40. Via a control input 42 the control valve 38 is activated by a pneumatic controller 44 which in turn may be connected to a central controller 46 of the motor vehicle. The control valve 38 may be implemented in situation or in the vicinity of the passageway elements, it being understood, however, that it may be sited elsewhere between pneumatic flow source and tire. The interior 24 in the vehicle tire 22 is connected via a pneumatic flow line 48 to an inlet valve 50 in the form of a conventional check valve provided in the region of the second cavity 36 of the second passageway element 28. By ways and means (not shown) it is in this region that an optional pressure sensor 49 (see FIG. 3) may be arranged which signals the target pressure of the vehicle tire 22 at any one time hard-wired or wireless to the pneumatic controller 44 and/or the central controller 46 of the motor vehicle. It is in this way that controlling the pressure in the vehicle tire 22 is made possible. The sensoric and control functions may be divided between the pneumatic controller 44 and the vehicular central controller 46 optionally, whereby the pneumatic controller 44 may also be an integral component of the vehicular central controller 46. It is, however, the best solution to arrange for all open and closed circuit control and pressure sensing to occur in the pneumatic controller 44 so that simply status and target signals are swapped with the vehicular central controller 46. Via the pressure sensor (not shown) the pressure data in the tire at any one time are signaled to the pneumatic controller 44 which compares the pressure data to the target data as programmed in the vehicular central controller 46 for the vehicle operation at that time. In accordance with how these data compare, the control valve 38 is activated, causing it to open and pressurize the annular passageway 35 with the pneumatic flow from the pneumatic flow source 40. In this arrangement, the vehicle tire interior 24 is inflated via the valve 50 (in this case a check valve) as long as the pressure in the annular passageway 35 exceeds the pressure in the vehicle tire 22. Once the target value has been attained the control valve 38 is deactivated, causing it to close to allow the excess pressure having formed in the annular passageway 35 to escape to the environment through the gap between the first passageway element 30 and the second passageway element 28, meaning that the annular passageway is purged. It is in this way that not only the pressure in the tire can be maintained at the required level, but that also a certain run-flat performance is maintained should the vehicle tire 22 have been damaged, as long as the pneumatic feed via the annular passageway 35 exceeds the pneumatic loss due to the tire being damaged.

To dump tire pressure there is arranged in the pneumatic flow line 48 an outlet valve 60 (not shown in FIG. 1) activated by the pneumatic controller 44 by means of which when actuated a pneumatic flow materializes from the tire into the environment, where necessary via the annular passageway 35.

Referring now to FIG. 2 there is illustrated an embodiment similar to that as shown in FIG. 1 but now including in addition to the annular passageway 35 an outlet annular passageway 52 formed by cavities 54, 56 in the second and first passageway element 28, 30. It is to be noted that components having the same function or are identical in the diverse embodiments are identified by having the same reference numbers throughout. Sited in the cavity 54 of the second passageway element 28 is the actuator surface of an outlet valve 60 connected, on the one hand, by the pneumatic flow line 62 to the vehicle tire interior 24 of the vehicle tire 22 and, for another, to an output 64 (see FIG. 3) into the environment. How this device works, as shown in FIG. 2, will now be explained with reference to FIG. 3 showing the circuitry in more detail.

Referring now to FIG. 3 there is illustrated how the inflated vehicle tire interior 24 is connected by the pneumatic flow line 48 to a pressure sensor 49, the readings of which are signaled wireless to the pneumatic controller 44. Connected via control lines to the control inputs of two control valves 38, 58 the pneumatic controller 44 controls these control valves as a function of the result of comparing the pressure value at any one time, as received by the pressure sensor 49, to predefined target values fed by the vehicular central controller 46 for predefined situations and conditions with the vehicle on the move to the pneumatic controller 44. When, for instance, the pressure in the tire is too low, the control valve 38 is actuated so that the annular passageway 35 is connected to the pneumatic flow source 40. The pneumatic flow source 40 contains a pneumatic flow, e.g. compressed air at a pressure higher than is necessarily for the tires ranging from e.g. 3 to 5 bar. It is understood that a compressor may serve as the pneumatic flow source. This pressure in the annular passageway 35 prompts the inlet valve 50 to open achieving a flow of compressed air via the pneumatic flow line 48 into the vehicle tire 22. But as soon as the target value is attained activation of the control valve 38 ceases and the pressure having built up in the annular passageway 35 escapes via the gap d between the first passageway element 30 and the second passageway element 28. This gap d is set via an assembly aid 32 configured as a tweaking adapter to which the first passageway element 30 can be defined axially relative to the second passageway element 28.

Should it turn out that the tire pressure is too high then the pneumatic controller 44 activates the second control valve 58, as a result of which the pressure-controlled outlet valve 60 opens to connect the pneumatic flow line 48 via the line 62 to the port 64 porting into the environment. It is in this way that air escapes from the vehicle tire interior 24 of the vehicle tire 22. As soon as the predefined target value is attained, activation of the second control valve 58 is halted, resulting in the excess pressure having built up in the outlet annular passageway 52 escaping through the gap d between the first passageway element 30 and the second passageway element 28, after which the outlet valve 60 closes, disconnecting the pneumatic flow line 48 from the port 64. It is in this way that each of all tires on the vehicle is either pressurized or depressurized in accordance with the environment and/or vehicle operation requirements. Depressurizing the tire may be wanted, e.g. when the tire pressure has built up excessively because of overheating or when the environment requirements are predominant, e.g. off the road when an excessive pressure in the tires is unwanted.

Instead of activating the valves via the controller 44 this may also be done by means of the compressed air flowing into the annular passageway as is claimed in the sub-claims 15 to 17. It is especially then that it is good practice to provide for the outlet a separate outlet passageway including a corresponding pressure control valve.

Eliminating valves activated isolated from the controller simplifies the engineering in making it more cost-effective.

Referring now to FIGS. 4 and 5 there is illustrated in conclusion a further alternative to that as shown in FIG. 1 in which inflating and deflating the tire is possible with just a single annular passageway 35 in making use of pressure control valves. The only difference between the annular passageway 35 of this embodiment as compared to that as shown in FIG. 1 is that the second passageway element 28 differs by both the check valve 50 and the control surface of the pressure-controlled outlet valve 60 from FIG. 3 are now arranged in the further cavity of annular passageway 36 of the second passageway element 28. Preferably, the second passageway element 28 features furthermore a sensor marking 70 e.g. in the form of a ferromagnetic pin, or an optical marking, which is sensed and signaled by a corresponding sensor at the first passageway element 30 which in signaling the position is likewise forwarded to the pneumatic controller 44.

Now, the annular passageway 35 is divided by the two webs 72, 74 into sectors 36 and 36 b, each separate from the other. As is clearly evident from FIG. 5 the first passageway element 30 has no cavity so that the annular passageway 35 is substantially formed by the sectors 36 a, 36 b in the second passageway element 28 and the facing side of the first passageway element 30. This now means that the control valve 38 is connected to the check valve 50 by a half-rotation of the vehicle wheel 12 for inflation and by the other half-rotation of the vehicle wheel 12 is connected to the actuator surface of the pressure-controlled outlet valve 60 for deflation. By correspondingly selecting the arrangement of the webs 72, 74 the one sector portion can be increased or decreased relative to the other, meaning that a plus in the one sector is a minus in the other. Thus, the individual components such as check valve 50, pressurized outlet valve 60, pneumatic flow line 62 in the second passageway element as well as the port 64 are no longer arranged as shown in FIG. 3 radially juxtaposed but in line in the circumferential direction of the annular passageway 35. Otherwise, however, the components are circuited the same in FIGS. 4 and 5 as in FIG. 3.

It is evident from the drawings that the annular passageway must not necessarily be formed by a cavity in two passageway elements 28, 30, but, as shown in FIG. 5, by the corresponding part of the annular passageway simply being formed by a wall. In addition to this, it may be an advantage when this wall even extends in the direction of the other passageway element which would result in a kind of non-contact labyrinth seal, further reducing the leakage flow through gap d.

It is understood that centrally nesting two annular passageways differing in diameter as shown in FIGS. 4 and 5 makes it possible to control the pressure, i.e. for inflation as well as deflation of each of two tires, such as, for instance, both tires of a twin assembly separately.

Referring now to FIGS. 6 and 7 there is illustrated another embodiment analogous to that as shown in FIGS. 2 and 3 including an annular passageway 35 and an outlet annular passageway 52, particularly evident from FIG. 7 being the low-profile assembly in the region of the disk brake flange.

Referring now to FIG. 8 there is illustrated an embodiment in which an additional annular passageway 105 is fully integrated in the second toroidal element 102 (indicated as a broken line in FIG. 8). This second toroidal element 102 is the element entrained in the rotation of the vehicle wheel in simultaneously representing the second passageway element which then forms a halved annular passageway 36.

At the front face of the toroidal element facing that of a complementary first toroidal element 100 at which the pneumatic flow source is connected via a control valve the integral annular passageway 105 has three ports, in each of which a check valve 103 is arranged protruding into the integral annular passageway 105 but not being able to open therefrom. Now, when the vehicle is on the move the outlet port (the valve port shown on the right in FIG. 8) of the first passageway element covers the corresponding port of a check valve, the latter opens to feed the pneumatic outflow into the integrated annular passageway 105 from which the pneumatic medium flows via the valve arranged in the integral annular passageway to the inlet side of the vehicle tire.

It is due to this integral annular passageway 105 closed off by check valves to the pneumatic inlet side that pressure losses are minimized.

To increase the degree of port by which the pneumatic flow outlet of the first toroidal element 100 (arranged substantially non-rotatable) covers the ports of the check valves, said first toroidal element 100 takes the form of the first passageway element as described above in which part of an annular passageway is already formed. It is because of this annular passageway part that a continual coverage between the outlet side of the first toroidal element 100 and the ports for the check valve 103 of the opposite second toroidal element 102 is assured, although, of course, it is just as possible that more than two ports may be provided with check valves in the second toroidal element.

The device in accordance with the invention functions as follows:

In a situation involving a rotating wheel, resulting in the first passageway element 30 being entrained in the rotation unlike the near stationary second passageway element 28, in one embodiment of the invention having no outlet passageway 52 the sole existing annular passageway 35 can be continually pressurized, enabling the tire to be inflated with the vehicle on the move. The same applies to the vehicle wheel when stationary since the inlet valve is continually in active connection with the pressurized annular passageway. Deflation is likewise possible with no problem via activation of the outlet valve.

In another embodiment including an annular passageway 35 and a outlet annular passageway 52 the function is similar since inlet and outlet are separated by two different annular passageways.

In an embodiment involving just a single annular passageway to which both the inlet valve and outlet valve are connected inflating/deflating the tire is the same with both the vehicle stationary and on the move: when the annular passageway is pressurized to less than the threshold value for the inlet valve, only the outlet valve opens and the tire is deflated, whilst when the annular passageway is pressurized which also opens the inlet valve the resulting deflation due to the outlet valve must be smaller than the inflation of the tire. In this situation the deflation due to the outlet valve needs to be added to the deflation resulting from leakage between the first and second passageway element.

In an embodiment in which the sole annular passageway 35 is separated by the pair of webs 72, 74 into two sectors, to inflate the tire the sector of the annular passageway 35 at which the inlet valve is provided needs to be pressurized. This sector needs to be selected to advantage larger than the sector of the outlet to also achieve inflation as quickly as possible when the vehicle is on the move at high speed. Since, however, the connection 33 can only be positioned every time via either the inlet sector or via the outlet sector, pressurizing the tire with the vehicle stationary in this situation is more complicated, resulting in the tire pressure in this embodiment not being controlled until the vehicle starts to move.

Referring now to FIGS. 9 to 13 there is illustrated a further example embodiment of the invention, FIG. 9 showing in a top-down view the brake disk 16 in which the second passageway element is contained nesting the first passageway element 30. Shown furthermore in FIG. 9 are the three inlet connections for the compressed air, all of which are delimited by a brake dust guard 18 from the brake disk to counteract the accumulation of brake dust. The example embodiment disclosed in this case comprises, on the one hand, an arrangement and embodiment of elements in accordance with the invention realizing inflation with the vehicle both stationary and on the move, it, on the other hand, also exemplifying how the arrangement and design of elements makes it possible to inflate the tire with the vehicle both stationary and on the move. Ultimately, however, the two cited alternatives may also be combined as evident from FIGS. 10 to 13, for instance, it only being in a combination of inflation “stationary” with “stationary” and “on the move” inflation, including an embodiment for brake disk release, that all three connectors 33 are needed, each provided for the three functions as cited.

Referring now to FIG. 10 there is illustrated a section taken along the line as shown in FIG. 9 through the connection port 33 intended for pressurization exclusively with the vehicle stationary, it guiding through the first passageway element 30 and ending in the cavity of the annular passageway 34 at the rear end of the first passageway element. In this case the brake disk is configured with its calipers so that they form the second passageway element 28 in which an outlet is included (see outlet of the air vortex) enabling the compressed air to be forwarded to the check valve 50 (not shown) and on to the interior of the tire. Whilst the first passageway element 30 is not entrained in the rotation of the vehicle tire, the second passageway element 28 rotates together with the brake disk 16 about the wheel axle 17. Accordingly, the section line as shown in FIG. 10 passes precisely through the outlet port of the second passageway element 28 to the control valve.

It is understood that although FIG. 10 depicts a combination of the two situations “tire pressurized only when stationary” and “tire pressurized when stationary and on the move”, this combination is not mandatory.

The following makes reference to the way the device functions as regards the features of the embodiment “tire pressurized only when stationary” as is indicated in FIG. 10 by the air vortex evident in the annular passageway. The pneumatic flow introduced at the connection port 33 into the cavity of the annular passageway elevates the pressure in the annular passageway as a result of which the first passageway element 30 is shifted contrary to the direction in which the pneumatic flow is introduced. It is this backshift of the first passageway element 30 that results in the pneumatic flow guided in the space between the first passageway element 30 and the second passageway element 28 being able to escape only via the outlet of the second passageway element 28 and not, for instance, via said space between the brake disk and the first passageway element 30 back to the site of the connection port 33, because due to the shift of the first passageway element 30 it is urged to the brake disk extension at the site of the connection port 33 so that the space between the first passageway element 30 and the second passageway element 28 is closed off. This contact guidance between the first passageway element 30 and the second passageway element 28 or brake disk 16 when pressurized results in frictional forces on rotating of the wheel so that pressurizing the vehicle tire in this embodiment is intended exclusively for when the vehicle is stationary. On discontinuation of pressurization the first passageway element 30 is able to move in the direction of pressurization at least to the extent that said frictional forces are eliminated to again minimize the wear between the first passageway element 30 and second passageway element 28 or brake disk 16. In other words under normal circumstances the first passageway element 30 when not pressurized is maintained without friction contact in the second passageway element 28 of the brake disk, it not until it is pressurized that the first passageway element 30 is urged back to the second passageway element 28 parallel to the inlet direction of the pneumatic flow so that the space between the first passageway element 30 and the second passageway element 28 is closed off.

Referring now to FIG. 11 there is illustrated an example embodiment in which pressurization is possible both when the vehicle is stationary and on the move, making it immediately clear, unlike the example as shown in FIG. 10, that the first passageway element 30 is not retracted contrary to the direction of the pneumatic flow in pressurization, as a result of which there is no friction contact between the first passageway element 30 and the second passageway element 28 which, on the other hand, also results in a certain loss in pressure needing to be accepted because of the space between the two passageway elements. The two illustrations in FIG. 11 show, for one thing, a variant in which the cavity of the annular passageway 34 exists in the first passageway element 30 (see variant illustrated on the left) and, for another, an example in which the cavity of the annular passageway 34 exists solely in the second passageway element 28 (see variant illustrated on the right).

But both sectional views lead through the outlet at the second passageway element 28 to the control valve (not shown).

It is understood that although this embodiment as evident from FIG. 11 is illustrated in conjunction with the example embodiment as shown in FIG. 10 it may also be engineered without the annular passageway structure at the end of the first passageway element 30 shown in FIG. 10. But the combination of both annular passageways as shown in FIG. 11 permits stationary pressurization by selecting the connection port 33 without any loss in pressure at the rear end of the first passageway element 30 as shown in FIG. 10. It is only when the tire is rotating about the wheel axle 17 that in this combination pressurization is implemented in accordance with FIG. 11.

Referring now to FIG. 12 there is illustrated how releasing the brake disk functions with reference to the embodiment as shown in FIGS. 9 to 13 by the connection port 33 leading to the passageways of the brake disk release 27 which at the end of the brake disk are open so that the pneumatic flow introduced through the brake disk release 27 can reemerge in realizing cooling of the brake disk. The lower illustration in FIG. 12 depicts a section taken through the openings of this brake disk release 27 making it evident how the middle connection port 33 of the three serves to release the brake disk whilst the other two connections 33 are provided for pressurization exclusively with the vehicle stationary respectively for the alternative embodiment of pressurization without displacement of the first passageway element 30 in the function as shown in FIG. 11 for pressurization with the vehicle stationary or on the move. Thus, depending on how the connection port 33 (see FIG. 9) is selected it is possible to release the brake disk and/or pressurize the tire.

Referring now to FIG. 13 there is illustrated in conclusion a variant of the example embodiment as shown in FIGS. 9 to 12 in which the first passageway element 30 is guided in an adapter which together with the brake disk forms the second passageway element and with the aid of which existing brake disk systems can be retrofitted with the pressurization system in accordance with the invention, for example. The adapter is bolted to the brake disk boss through openings in the latter. In addition, FIG. 13 illustrates, the same as already disclosed in FIG. 11, how tire pressurization functions with the vehicle on the move or stationary. In this arrangement the first passageway element 30 is not shifted by the pressurization, meaning that although this diminishes wear, on the other hand, a loss in pressure due to compressed air escaping through the space between the first passageway element 30 and the second passageway element 28 has to be accepted.

It is understood that the all features involved in controlling tire pressurization, vehicle control as well as details as to the pressure lines and sensors as described with reference to FIGS. 1 to 8 read, of course, just the same to this embodiment.

As regards the drawings it is furthermore to be noticed that the number and dimensioning of the individual components may correspond to air flow handling in each case, as a result of which e.g. several control valves may be circuited in parallel, the same applying to the check valve 50 or pressurized outlet valve 60 when a larger cross-section is wanted and the size of the annular passageway is not sufficient for the arrangement of correspondingly large dimensioned valves. It is just as possible that several passageways may be provided nested differing in radius in keeping with the air flow needing to be handled.

As regards the size, i.e. the volume of the annular passageways 35, 52 it is to be noted that the annular passageway is merely required to ensure that the corresponding pressure provided by the control valves 38, 58 is applied to full scope where possible, for, selecting each passageway volume too small results in a drop in pressure the further away from the control valves 38, 58 the flow is, aggravated all the more by the size of the gap d between the first and second passageway element 30, 28. Thus, the passageways need to be sized so that at the opposite end of the annular passageway, i.e. via the control valve 38 turned through 180° a pressure always exists that is still considerably higher than the pressure in the interior 24 of the vehicle tire 22.

Referring now to FIG. 14 there is illustrated a flow valve developed specially for use as an inlet valve and as an outlet valve for the invention as described above. In the topmost illustration of this FIG. a standardized flow valve with the mechanism of a check valve is shown. The from bottom to top incoming flow of air is capable of shifting the check piston in the inlet direction of the valve—i.e. upwards—so that compressed air streams past the piston into the vehicle tire, for instance. Discontinuing pressurization causes the check piston to sink back into a resting position in which it prevents an outflow of air/gas in the opposite direction.

Referring now to the middle illustration shown in FIG. 14 a first variant is depicted as a modification of the flow valve capable of serving as a pressure outlet valve. For this purpose the valve, for one thing, is closed off at the end of pressurization by a deformable cap. For another, at least one outlet valve is provided to dump the compressed air. Machined in the shell of the valve are two side passageways so that the valve can now be activated by compressed air (see arrow indicating the direction of the flow) deforming the closure cap, to then lift the check piston so that air/gas can be dumped by streaming past the piston in the reverse direction to feed compressed air to the outlet ports A.

Referring now to the bottom illustration shown in FIG. 14 there is illustrated an alternative modification in which instead of the cap (see middle illustration shown in FIG. 14) a piston closes off the end of the check element. The closure piston is capable of closing off the valve contrary to the inlet flow direction of the compressed air. Now, pressurizing the valve with compressed air lifts the check element so that air/gas can be dumped by streaming past the piston in the reverse direction to feed compressed air to the outlet ports A.

### LIST OF REFERENCE NUMBERS

10 compressed air device
12 motor vehicle wheel
14 stationary part
16 brake disk
17 wheel axle
18 brake dust guard
20 rim
22 vehicle tire
24 vehicle tire interior
26 brake disk mount
27 brake disk release
28 second passageway element
30 first passageway element
31 adapter
32 assembly aid
33 connection
34 cavity of annular passageway
35 annular passageway
36 further cavity of annular passageway
36 a/b sectors of annular passageway
38 control valve
40 pneumatic flow source
42 control input
44 pneumatic controller
46 vehicular controller
48 pneumatic flow line
49 pressure sensor
50 inlet (check) valve
52 outlet annular passageway
54, 56 cavity
58 second control valve
60 outlet valve
62 pneumatic flow line
64 low-pressure port
70 sensor marking
71 ferromagnetic element
72 web
74 web
100 first toroidal element
102 second toroidal element
103 check valve
105 integral annular passageway
107 flow valve
109 closure cap
A outlet port
d gap

1. A device for setting the gas pressure in a motor vehicle tire (22), comprising:
at least one first passageway element (30) arranged substantially non-rotationally in proximity to a wheel axle (17) and which forms a part (34) of an annular passageway (35) arranged concentrically with the wheel axle (17), said first passageway element (30) comprising a connection (33) for a pneumatic flow line connected to a pneumatic flow source (40),
at least one second passageway element (28) rotatable together with the motor vehicle tire (22) forming another part (36) of the annular passageway (35) and connected to the interior (24) of the motor vehicle tire (22) by means of an inlet valve (50),
wherein said first passageway element (30) and said second passageway element (28) face each other by their parts (34,36) forming said annular passageway (35).

2. The device as set forth in claim 1, characterized in that said first and second first passageway element (30,28) take the shape of annular disks arranged concentric to the wheel axle (17).

3. The device as set forth in claim 1, characterized in that an assembly aid (32) for at least one passageway element (30) is provided, permitting setting a defined gap (d) ranging from 0.05 mm to 3 mm, particularly from 0.2 mm to 1 mm between the facing parts of the first (30) and second passageway element (28) forming the annular passageway.

4. The device as set forth in claim 3, characterized in that said connection (33) is a control valve activatable by being activated by a pneumatic controller (44) in the porting direction.

5. The device as set forth in claim 3, characterized in that said gap (d) between the facing, sealing edges of the first and second passageway element (30, 38) is located in a plane transversely to the wheel axle (17).

6. The device as set forth in claim 1, characterized in that provided in said second passageway element (28) is a solenoid-activatable outlet valve (60) connecting the annular passageway (35) to the interior of the vehicle tire and which when actuated exhausts gas from the tire.

7. The device as set forth in claim 1, characterized by an outlet annular passageway (52) configured concentric to said annular passageway (35) and formed between the first passageway element (30) and the second passageway element (28), wherein said outlet annular passageway (52) comprises in the first passageway element (30) a second control valve (58), particularly a control valve for a pneumatic feeder connected to the pneumatic flow source (40), and the second passageway element (28) connecting the actuating surface of an outlet valve (60) which when not actuated separates the interior (24) of the vehicle tire (22) from a low-pressure area (64), particularly the environment.

8. The device as set forth in claim 7, characterized in that said annular passageway (35) and outlet annular passageway (52) are configured in the first and second passageway element (30, 28), the annular passageway (35) and outlet annular passageway (52) being configured as annular passageways differing in diameter arranged radially juxtaposed each separate from the other.

9. The device as set forth in claim 8, characterized in that said annular passageway (35) is separated from the outlet annular passageway (52) by an axially oriented web.

10. The device as set forth in claim 1, characterized in that arranged in said part (36) of the second passageway element (28) forming the annular passageway is an actuator for an outlet valve (60) angularly spaced away from the inlet valve (50) and that said connection (38) of the pneumatic flow line in the first passageway element (30) contains a controllable valve.

11. The device as set forth in claim 10, characterized in that said pneumatic controller (44) provides for actuation of the valve as a function of the relative position of the first and second passageway element (30, 28) each relative to the other.

12. The device as set forth in claim 11, characterized in that said passageway elements (30,28) are arranged within a flange for a brake disk (16).

13. The device as set forth in claim 10, characterized in that said first passageway element (30) simply forms a wall of the annular passageway (35) and that a part (36) of the cavity forming the annular passageway (35) is divided in the second passageway element (28) by two radially oriented webs (72, 74) into two sectors (36 a,b), wherein in the one sector (36a) the inlet valve (50) and in the other sector (36b) the actuating surface of the outlet valve (60) are arranged.

14. The device as set forth in claim 13, characterized in that a sensor detector (70) is provided for sensing the rotary position of the second passageway element (28) respectively the relative position between the first (30) and second (28) passageway element.

15. The device as set forth in claim 14, characterized in that said sensor detector (70) comprises a ferromagnetic element (71) arranged at the second passageway element (28) and arranged at the first passageway element (30) a solenoid connected to the pneumatic controller (44) for closed loop control of the air pressure in the vehicle tire (22).

16. The device as set forth in claim 15, characterized in that said second passageway element (28) comprises a wireless pressure sensor (49) signaling the pressure sensed at any one time to the pneumatic controller (44) for closed loop control of the air pressure in the vehicle tire (22) and/or to the vehicular central controller (46).

17. The device as set forth in claim 16, characterized in that said check valve (50) and outlet valve (60) are pneumatically activatable via the pressure of the pneumatic flow source (40), the activating pressure for the outlet valve being selected lower than the activating pressure for the inlet valve so that when inflating the annular passageway with compressed air at a predefined pressure either the outlet valve by itself or together with the inlet valve are actuated.

18. A device for setting gas pressure in a vehicle tire (22) comprising:
a first toroidal element (100) arranged in proximity to a wheel axle (17) of the motor vehicle, said first toroidal element (100) have a front side facing a front surface together with a second toroidal element (102) rotatable together with the vehicle tire (22), whereby provided in said first toroidal element (100) is a connection (33) for a pneumatic flow line (48) connecting a pneumatic flow source (40), the gas outlet of which opens coaxially at the front side of the first toroidal element (100), and whereby the second toroidal element (102) comprises an integral annular passageway (105) arranged coaxially thereto which is opened via coaxial ports to a front face of the second element, in one of said ports a check valve (50) being arranged connected to a vehicle tire interior (24) of the vehicle tire (22) and wherein in the remaining ports check valves (103) open from the front face of the second toroidal element (102) into the integral annular passageway (105).

19. The device as set forth in claim 18, characterized in that said first toroidal element (100) is formed by said first passageway element (30) and that a part (34) of the annular passageway (35) formed by the first toroidal element (100) is shaped so that said annular passageway is always effectively connected to at least one check valve (103) of the integral annular passageway (105).

20. The device as set forth in claim 19, characterized in that said second toroidal element (102) is formed by the second passageway element (28).

21. (canceled)
